(19) United States
(12) Patent Application Publication
(10) Pub. No.: US 2017/0142471 A1
(43) Pub. Date: May 18, 2017

(54) Individual Real-Time Live Video Streaming Method and Live System for Runways

(71) Applicant: Shanghai Huweihan Information Technology Co., Ltd, Shanghai (CN)

(72) Inventors: Speer Han, Shanghai (CN); Weil Cheng, Shanghai (CN)

(21) Appl. No.: 14/944,233

(22) Filed: Nov. 18, 2015

(51) Int. Cl. H04N 21/4223; H04L 29/08; H04N 21/222; H04N 21/2187; H04N 21/462; H04N 21/643; H04L 29/06; H04N 21/218

(52) U.S. Cl. CPC H04N 21/4223; H04L 65/4069; H04L 67/10; H04N 21/21805; H04N 21/2187; H04N 21/4622; H04N 21/64322; H04N 21/2223

(57) ABSTRACT

This invention refers to an individual real-time live video streaming method and system. The system includes mobile terminal, video receiving terminal, IP camera and cloud server. The mobile terminal includes GPS location mode and first wireless communication mode. The video receiving terminals include second wireless communication mode, video switching mode and video playing mode. Several IP cameras are put at both sides of the runways with crossed fixation. GPS location mode can send the runners' location information to video receiving terminals by first wireless communication and cloud server. IP cameras send the videos they taken to the video receiving terminals by cloud server. The second wireless communication mode sends both the location information and videos to video switching mode. The video switching mode will switch the screen to the said runner's videos which are taken by the IP cameras in the certain locations in real-time, and play it out.

### TECHNOLOGY FIELD

This invention is within the area of video display, specifically referring to an individual real-time live video streaming method and live system for runways.

### BACKGROUND TECHNOLOGY

With the increasing improvement of living standard, People's appeal for health and sports are becoming continuously stronger. In view of the fact that there are no special place and equipment requirements for running, and besides, running is beneficial to cardiopulmonary function and blood circulation, more and more people throw themselves into running. Even the tickets for marathon race, which is not popular at all a few years ago, are hard to get recently. Nowadays, the sports event broadcasting is relatively monotonous, only TV broadcasting counts. Normally, TV stations shoot different locations and directions at the same time with several cameras. Considering that there are so many athletes running on the runway, which makes it impossible for those cameras to shoot everyone at the same time. Moreover, those cameras mostly only focus on the key participants, such as superstars or runners running ahead. What's more, due to the time limitation, once the runners running ahead arrived, TV broadcasting ends. People cannot watch their specific runners all the time around.

Invention Content

In order to solve the problems motioned above, the invention described in this article provides an individual live video streaming method and live system for runways.

The technology concept adopted for this invention is as follows: an individual real-time live video streaming method for runways includes following steps: 1) Set an individual real-time live video streaming system equipped with several mobile terminals, several video receiving terminals, several IP cameras and a cloud sever; The mobile terminals which are worn by the runners should have the network communication function and GPS locate function. The video receiving terminals possess the network communication function, video switching function and real-time playing function; 2) IP cameras are put at both sides of the runways with crossed fixation. The IP cameras on one side should be corresponding with the middle arbitrary point between the two IP cameras at the opposite side. Each IP camera shoots the real-time videos of each runner, and sends the videos to the cloud server. The cloud server will send the received videos to the video receiving terminal by network communication. 3) The mobile terminals can locate the runners in real-time, and send the location information to the cloud server timely. The cloud server will send the received the location information to the video receiving terminals; 4) According to the runner's location information, the video receiving terminal will switch to the said runner's video which is taken by the IP cameras in this location at any time, and play it out.

An individual real-time live video streaming system based the said individual real-time live video streaming method features as follows: It includes several mobile terminals, several video receiving terminal, several IP cameras and cloud server. The said mobile terminals include GPS positioning mode and first wireless communication mode. The said video receiving terminals include second wireless communication mode, video switching mode and video playing mode. The said several IP cameras are put at both sides of the runways with crossed fixation. The IP cameras on one side should be corresponding with the middle arbitrary point between the two IP cameras at the opposite side. The scenes are directly facing to the runway. The said mobile terminals worn by the runners include GPS location mode can position the runners' location timely, and send the location information to the said cloud server by the said first wireless communication; The said cloud server send the location information to the said video receiving terminals by network; The IP cameras send videos taken by them to the said could server by network. The said cloud server send the location information to the said video receiving terminals by network; The said second wireless communication mode will send the both location information and videos to the said video switching mode. The video switching mode will switch the screen to the said runner's videos which are taken by the IP cameras in the certain locations in real-time, and play it out.

By adopting the mentioned technology concept, the benefits of this invention are as follows: It can shoot every athlete, and can real-timingly broadcast every athlete's video from beginning to end, which can improve the interactivity of each sport dramatically.

### FIGURE LEGENDS

FIG. 1 is the structural representation of an individual real-time live video streaming system for runways;

FIG. 2 is the IP cameras' layout representation in an actual Marathon runway.

The numbers in the figures are representing: 1. mobile terminal; 2. video receiving terminal; 3. IP cameras; 4. Cloud server; 11. GPS location mode; 12. first wireless communication mode; 21. second wireless communication mode; 22. video switching mode; 23. video playing mode.

### THE DETAIL IMPLEMENTATION METHOD

Following is the detail illustration for this invention supported both by figures and actual implementation examples

The individual real-time live video streaming method for runways provided by this invention includes following steps:

1) Set an individual live video streaming system equipped with several mobile terminals 1, several video receiving terminals 2, several IP cameras 3 and a cloud sever 4; The mobile terminals 1 which are worn by the runners should have the network communication function and GPS locate function. The video receiving terminals 2 possess the network communication function, video switching function and real-time playing function.

2) IP cameras 3 are put at both sides of the runways with crossed fixation. The IP cameras 3 on one side should be corresponding with the middle arbitrary point between the two IP cameras 3 at the opposite side. Each IP camera 3 shoots the real-time videos of each runner, and sends the videos to the cloud server 4. The cloud server 4 will send the received videos to the video receiving terminal 2 by network communication. Following is the detail process:

Predicting that the runway's length is x m. Allocate an IP camera 3 every m, and totally we need x IP cameras 3. Among them, 1, 3, 5 . . . IP cameras 3 are put at one side of the runway uniformly, while 2, 4, 6 . . . IP cameras 3 are uniformly put at the opposite side of the runway. The distance between the two neighboring IP cameras 3 is 2 m. The first IP camera 3 shoot the videos from 0-m, the second IP camera 3 shoot the videos from m-2 m, . . . , the x IP cameras 3 shoot the videos from (x-1) m-xm. X IP cameras 3 send their specific videos to the cloud server continuously.

3) The mobile terminals 1 worn by runners can locate the runners in real-time, and send the location information to the cloud server 4. Cloud server 4 sends the location information to the video receiving terminals 2.

4) According to the runner's location information, the video receiving terminal 2 will switch to the said runner's video which is taken by the IP cameras 3 in this location at any time, and play it out continuously, so that people can watch the whole running videos of their specific runners.

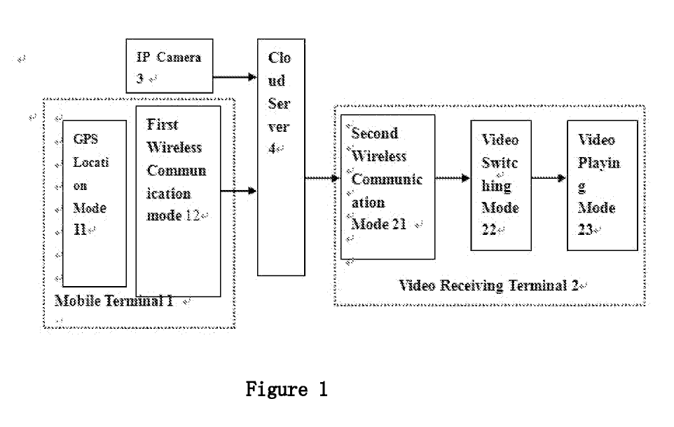

As shown in the FIG. 1, based on the said individual real-time live video streaming method, this invention also provides an individual real-time live video streaming system for runways, which includes several mobile terminals 1, several video receiving terminals 2, several IP cameras 3 and cloud server 4. Among them, mobile terminal 1 includes GPS location mode 11 and first wireless communication mode 12. Video receiving terminal 2 includes second wireless communication 21, video switching mode 22 and video playing mode 23. The said several IP cameras 3 are put at both sides of the runways with crossed fixation. The IP cameras 3 on one side should be corresponding with the middle arbitrary point between the two IP cameras 3 at the opposite side. The scenes are directly facing to the runway. The said mobile terminals 1 worn by the runners include GPS location mode 11 can position the runners' location timely, and send the location information to the said cloud server 4 by the said first wireless communication 12; The said cloud server 4 send the location information to the said video receiving terminals 2 by network; The IP cameras 3 send videos taken by them to the said could server 4 by network. The said cloud server 4 send the location information to the said video receiving terminals 3 by network; The said second wireless communication 21 mode will send the both location information and videos to the said video switching mode 22. According to the location information, the said video switching mode 22 switch the videos to a runner in specific area videos taken by that IP camera 3, and send them to video playing mode 23 to play them out. The audience can watch the whole running period of their specific runner by the video receiving terminals 2.

This invention—an individual real-time live video streaming system takes the same attitude to both every runner and their audiences, which can form a big ascending and descending video chain. Every audience can watch the complete and continuous videos of their specific runners. Moreover, the videos received by the video receiving terminals 2 can be broadcasted on the internet, which can help people to acknowledge the competition thoroughly.

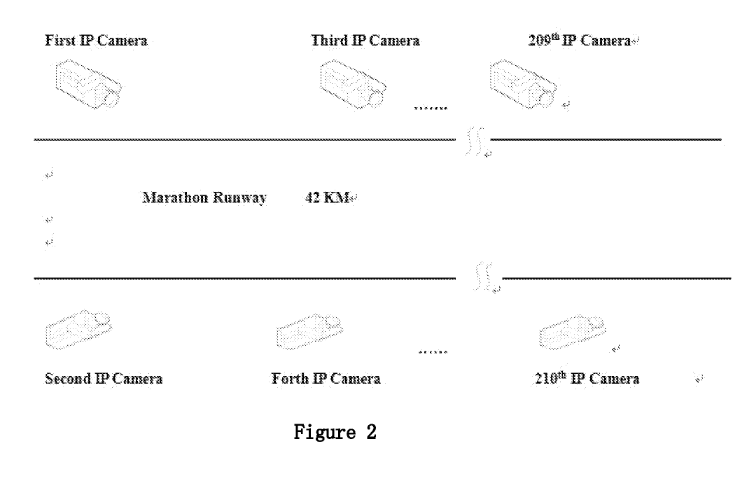

Actual implementation example: This invention that is an individual real-time live video streaming method and system can be utilized for marathon runways. As shown in FIG. 2, 210 IP cameras 3 are allocate at both sides of the marathon runway with crossed fixation. The distance between the neighboring two cameras 3 is 400 meters. Each IP cameras 3's angle and location is fixed. During the marathon race, those 210 IP cameras 3 are continuously sending the videos they shot to the cloud server 4. Thus, audience can watch the marathon race as convenient as network stream videos. The mobile terminals 1 worn by the runners will send the real-time location to the cloud server 4. Meantime, those 210 IP cameras 3 send 210 continuous videos to the cloud server 4. According to the runners' location information, video receiving terminals 2, as to the IP cameras 3 sequence, switch the corresponding IP cameras 3's videos in real-time.

When a runner is running between the areas from 0-200 m, the first IP camera 3 shoots the video for him. Meanwhile, video receiving terminal 2 broadcasts the videos taken by the first IP camera 3. When this runner is running between the areas from 200-400 m, the second camera shoots the video for him. Meanwhile, video receiving terminal 2 broadcasts the videos taken by the second IP camera 3 and by this analogy. Until this runner runs into the areas taken by the 210^{th} IP camera 3, and then breasts the yarn. The video receiving terminal 2 switch the screen to the videos taken by the 210^{th} IP camera. Regarding this video receiving terminal 2, it can continuously broadcast the whole running videos for this runner. For people who are watching this runner, they can watch this runner's image continuously and completely.

This invention is not limited to the above best implementation method. Anybody inspired by this invention, can produce other various kinds of products. However, no matter any changes happened in the form of structure or shape, any same or similar technology concept should be covered by this invention.

1. A individual real-time live video streaming method for runways provided by this invention includes following steps:
1) Set an individual live video streaming system equipped with several mobile terminals, several video receiving terminals, several IP cameras and a cloud sever; The mobile terminals which are worn by the runners should have the network communication function and GPS locate function. The video receiving terminals possess the network communication function, video switching function and real-time playing function;
2) IP cameras are put at both sides of the runways with crossed fixation. The IP cameras on one side should be corresponding with the middle arbitrary point between the two IP cameras at the opposite side. Each IP camera 3 shoots the real-time videos of each runner, and sends the videos to the cloud server. The cloud server will send the received videos to the video receiving terminal by network communication;
3) The mobile terminals 1 worn by runners can locate the runners in real-time, and send the location information to the cloud server. Cloud server sends the location information to the video receiving terminals;
4) According to the runner's location information, the video receiving terminal will switch to the said runner's video which is taken by the IP cameras in this location in real-time, and play it out continuously.

2. An individual real-time live video streaming system based on the individual real-time live video streaming mentioned in claim 1 features as follows: It includes several mobile terminals, several video receiving terminal, several IP cameras and cloud server. The said mobile terminals include GPS positioning mode and first wireless communication mode. The said video receiving terminals include second wireless communication mode, video switching mode and video playing mode; The said several IP cameras are put at both sides of the runways with crossed fixation. The IP cameras on one side should be corresponding with the middle arbitrary point between the two IP cameras at the opposite side. The scenes are directly facing to the runway. The said mobile terminals worn by the runners include GPS location mode can position the runners' location timely, and send the location information to the said cloud server by the said first wireless communication; The said cloud server send the location information to the said video receiving terminals by network; The IP cameras send videos taken by them to the said could server by network. The said cloud server send the location information to the said video receiving terminals by network; The said second wireless communication mode will send the both location information and videos to the said video switching mode. The video switching mode will switch the screen to the said runner's videos which are taken by the IP cameras in the certain locations in real-time, and play it out.
